(19) United States
(12) Patent Application Publication
(10) Pub. No.: US 2013/0094815 A1
(43) Pub. Date: Apr. 18, 2013

(54) OPTICAL FIBER CONNECTOR AND ADAPTER CAPABLE OF PREVENTING DUST

(71) Applicant: Yu Ting CHANG, New Taipei City (TW)

(72) Inventor: Yu Ting CHANG, New Taipei City (TW)

(73) Assignee: PROTAI PHOTONIC CO., LTD., New Taipei City (TW)

(21) Appl. No.: 13/420,712

(22) Filed: Mar. 15, 2012

(30) Foreign Application Priority Data
Oct. 17, 2011 (CN) 201110314455.7

(51) Int. Cl. G02B 6/36; G02B 6/00

(52) U.S. Cl. 385/78; 385/134

(57) ABSTRACT

The present disclosure provides an optical fiber connector, comprising: a hollow housing, wherein an annular protrusion is formed on inner walls of the housing; a ferrule holder positioned within the housing; a spring positioned to push the ferrule holder toward the annular protrusion; a ferrule mounted on the ferrule holder, wherein the ferrule is pushed through the annular protrusion; and an elastic body positioned around the ferrule holder and in contact with the inner walls of the housing.

### CROSS REFERENCE TO RELATED APPLICATION

This application claims the priority benefit of China Patent Application Serial Number 201110314455.7 filed Oct. 17, 2011, the full disclosure of which is incorporated herein by reference.

### BACKGROUND OF THE INVENTION

1. Field of the Invention

The present invention relates to an optical fiber connector and an optical fiber adapter, and more particularly, to an optical fiber connector and an optical fiber adapter capable of preventing dust.

2. Description of the Related Art

Fiber optics has revolutionized communication throughout the world. With the increased used of fiber optics it has become increasingly important to be able to connect and disconnect fiber optic cables from various sources. Two fiber optic cables can be optically coupled so that they are in communication with each other by using connectors and an adapter, thereby putting each fiber optic cable in communication with the other. The connectors are placed on the end of each cable and then plugged into the adapter. The adapter has two openings each one designed to receive a connector.

However, when an optical fiber connector is inserted into an optical fiber adapter, a narrow channel will be present between the connector and the inner walls of the adapter. Thus, external dust or water can still pass through this narrow space to contaminate the ferrule of the connector.

Accordingly, there exists a need to provide a solution to solve the aforesaid problems.

### SUMMARY OF THE INVENTION

The present disclosure provides an optical fiber connector, comprising: a hollow housing, wherein an annular protrusion is formed on inner walls of the housing; a ferrule holder positioned within the housing; a spring positioned to push the ferrule holder toward the annular protrusion; a ferrule mounted on the ferrule holder, wherein the ferrule is pushed through the annular protrusion; and an elastic body positioned around the ferrule holder and in contact with the inner walls of the housing.

The present disclosure further provides an optical fiber adapter, comprising: a hollow main body; a pair of inner housings positioned within the main body, each of the inner housings having a flange and a hollow cylinder, the flange having a front side and a back side, the cylinder extending from the front side, the cylinder having an opening formed on the back side of the flange, wherein the back sides of the flanges of the two inner housings are attached to each other; and an elastic body sandwiched in between the flanges of the two inner housings and positioned around the openings on the back sides of the flanges.

The foregoing, as well as additional objects, features and advantages of the disclosure will be more readily apparent from the following detailed description, which proceeds with reference to the accompanying drawings.

### BRIEF DESCRIPTION OF THE DRAWINGS

FIG. 1a is an elevated perspective view of a conventional LC type optical fiber connector.

FIG. 1b is a cross-sectional view of the optical fiber connector of FIG. 1a.

FIG. 2a is an elevated perspective view of a conventional duplex LC type optical fiber adapter.

FIG. 2b is a cross-sectional view of the optical fiber adapter of FIG. 2a.

FIG. 3a is a cross-sectional view of the optical fiber connector of the present disclosure.

FIG. 3b is an elevated perspective view illustrating that an annular elastic body is positioned around the ferrule holder of the optical fiber connector of the present disclosure.

FIG. 4 is a cross-sectional view illustrating that the optical fiber connector of the present disclosure is inserted into the optical fiber adapter of FIG. 2a.

FIG. 5a is a cross-sectional view of the optical fiber adapter of the present disclosure.

FIG. 5b is an exploded perspective view illustrating that the annular elastic bodies are positioned between the flanges of the inner housings according to the present disclosure.

FIG. 6 is a cross-sectional view illustrating that the optical fiber connector of FIG. 1a is inserted into the optical fiber adapter of the present disclosure.

### DETAILED DESCRIPTION OF THE PREFERRED EMBODIMENT

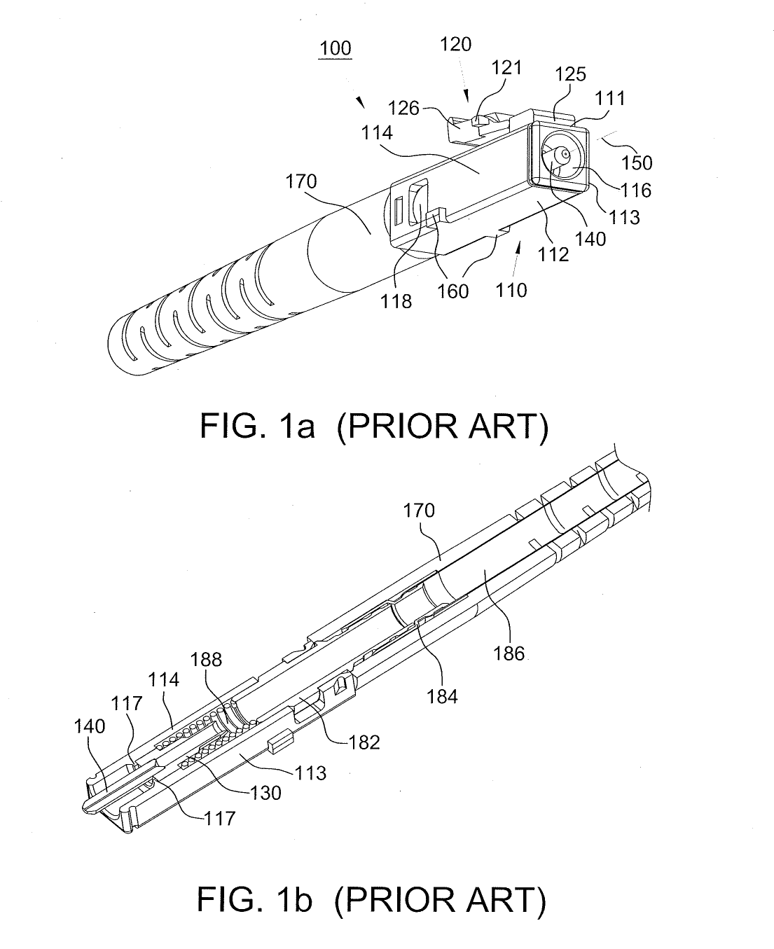

Referring to FIGS. 1a and 1b, a conventional LC type optical fiber connector 100 has a generally rectangular shape with a square cross section. The connector 100 includes a rectangular hollow housing 110 comprised of a top side-wall 111, a bottom side-wall 112, a right side-wall 113 and a left side-wall 114, wherein the right side-wall 113 is positioned opposite to the left side-wall 114 and connects with the bottom side-wall 112 and the top side-wall 111. A latch 120 is molded into the top side-wall 111 and includes a living hinge 125 which allows the tab 126 to be moved up and down in a direction perpendicular to the central axis 150-150 of the connector 100. The latch 120 includes a pair of protrusions 121 that are positioned on opposing sides of the tab 126. In addition, a ferrule 140 protrudes from a circular opening 116 on the front end of the housing 110. A spring 188 is located within the housing 110 to allow the ferrule 140 to move back and forth through the opening 116. A pair of protrusions 160 is positioned on the right side-wall 113 and left side-wall 114, respectively. A rectangular opening 118 is formed on each of the right side-wall 113 and left side-wall 114. A boot 170 extends from the rear end of the housing 110.

In addition, the connector 100 further includes a ferrule holder 130, a back post 182, a crimp ring 184 and a shrink tube 186, wherein the ferrule holder 130 and back post 182 are located inside the housing 110. The ferrule 140 has one end mounted on the ferrule holder 130. The spring 188 is arranged between the ferrule holder 130 and the back post 182. The spring 188 pushes the ferrule holder 130 forward such that the front end of the ferrule holder 130 is brought into contact with an annular protrusion 117 on inner walls of the housing 110. The ferrule 140 is pushed through the annular protrusion 117 and protrudes from the opening 116 of the housing 110.

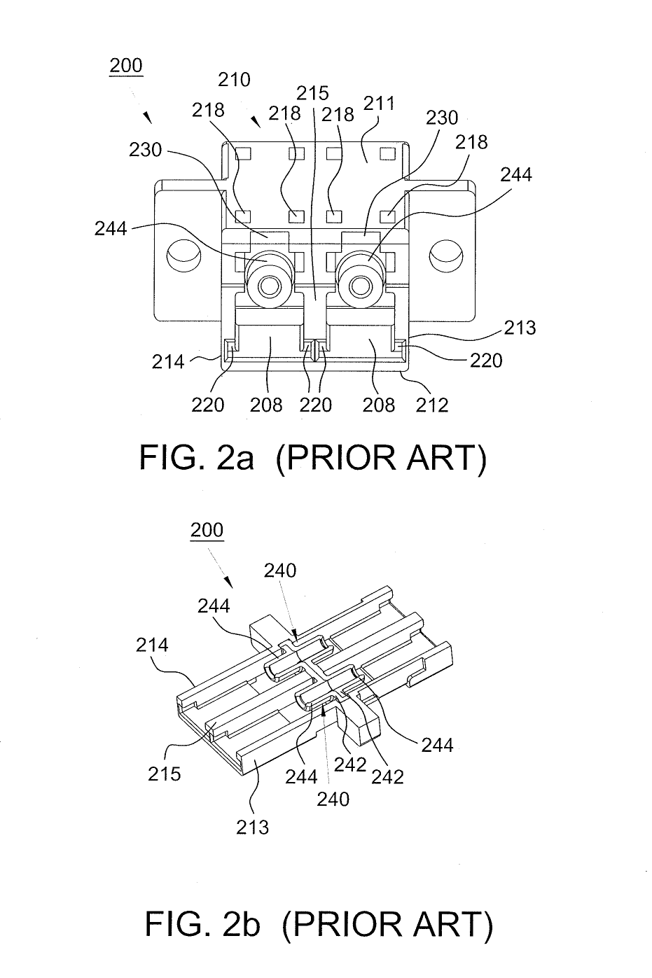

Referring to FIGS. 2a and 2b, a conventional LC type optical fiber adapter 200, such as an LC duplex adapter includes a generally rectangular main body 210. The main body 210 has an axial cavity defined by a top side-wall 211, a bottom side-wall 212, a right side-wall 213 and a left side-wall 214. The axial cavity is divided into two halves by a compartment wall 215 that is parallel to the right side-wall 213 and left side-wall 214 and connects with the top side-wall 211 and bottom side-wall 212. The half of the axial cavity defined by the top side-wall 211, bottom side-wall 212, compartment wall 215 and right side-wall 213 is named as the right axial cavity and the other half of the axial cavity defined by the top side-wall 211, bottom side-wall 212, compartment wall 215 and left side-wall 214 is named as the left axial cavity. Each of the right and left axial cavities has an opening 208. A pair of indentations 220 mating with the protrusions 160 on the connector 100 is arranged in the left axial cavity on the left side-wall 214 and compartment wall 215, respectively. Similarly, the indentations 220 are also arranged in the right axial cavity on the right side-wall 213 and compartment wall 215, respectively. When the connector 100 of FIG. 1 a is fully inserted into the adapter 200 through either of the openings 208, the protrusions 160 on the connector 100 will be placed in the indentations 220. In addition, the adapter 200 further includes reciprocal locking mechanisms 230 which, referring to FIG. 1a, mate with the latch 120, thereby securely interlocking the connector 100 with the adapter 200 when the connector 100 is completely inserted into the adapter 200.

A pair of inner housings 240 is placed within the main body 210. Each of the inner housings 240 includes a generally rectangular flange 242 and two hollow cylinders 244 extending from the front side of the flange 242. The two cylinders 244 are positioned within the left and right axial cavities, respectively to receive the ferrule 140 of the connector 100. The two inner housings 240 are configured together by attaching the flanges 242 thereof to each other in a back to back fashion.

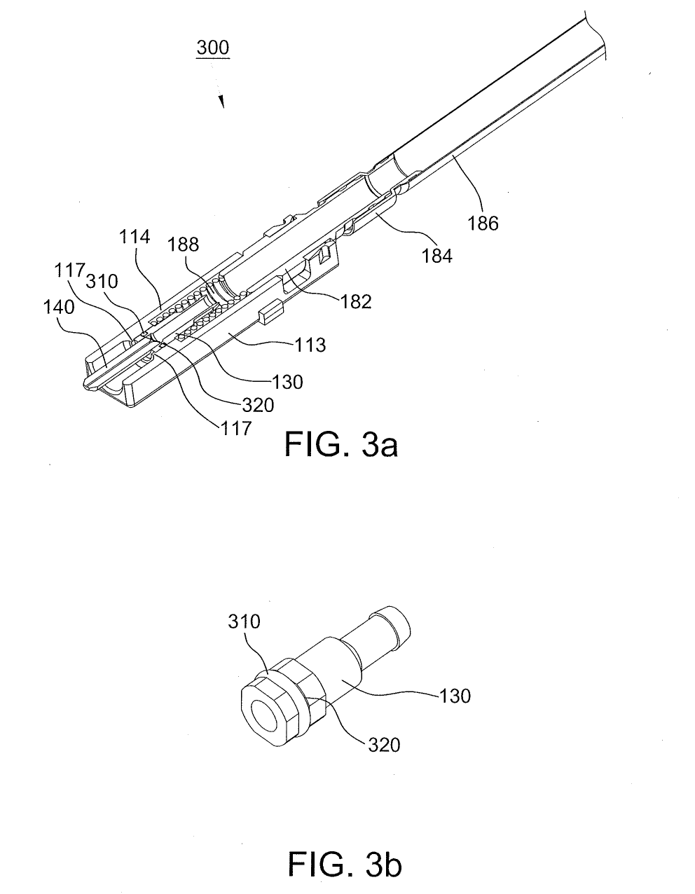

Referring to FIGS. 3a and 3b, the optical fiber connector 300 according to the present disclosure is substantially the same as the optical fiber connector 100 of FIG. 1, where identical reference numbers has been used when designating substantially identical elements that are common to the figures. However, the connector 300 of the present disclosure further has an annular indentation 320 formed on outer walls of the ferrule holder 130. An annular elastic body 310 is positioned in the indentation 320 and is in tight contact with inner walls of the housing 110.

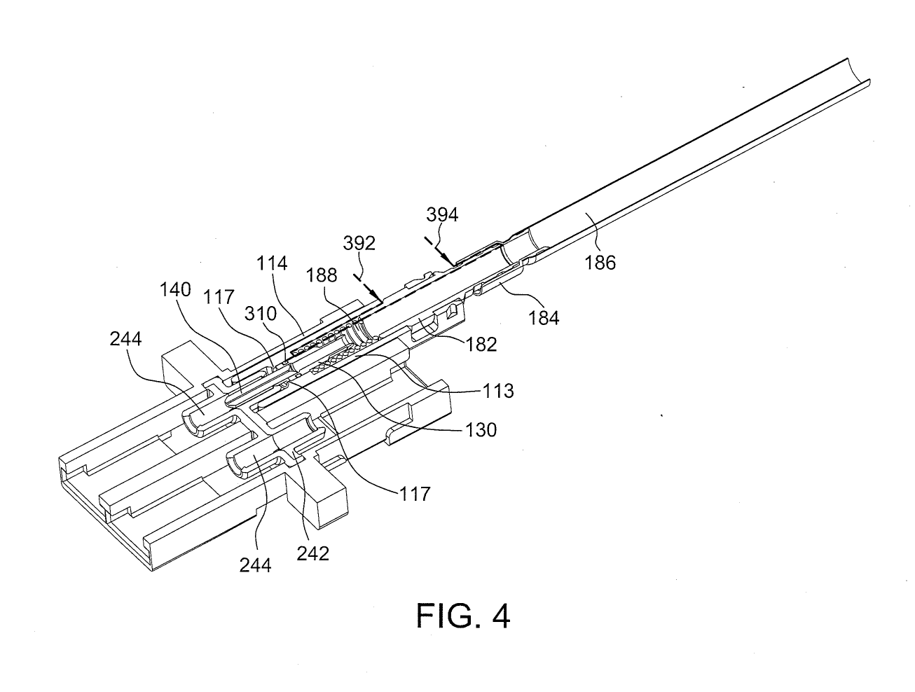

Referring to FIG. 4, when the connector 300 of the present disclosure is fully inserted into either of the left and right axial cavities of the adapter 200, the hollow cylinder 244 of the adapter 200 will be inserted into the connector 300 through the opening 116 and the ferrule 140 of the connector 300 will be inserted into the hollow cylinder 244 of the adapter 200. Because the annular elastic body 310 around the ferrule holder 130 is arranged in tight contact with the inner walls of the housing 110, external dust and water will fail to enter the hollow cylinder 244 along the routes 392 and 394 to contaminate the ferrule 140 therein when the connector 300 is fully inserted into the adapter 200.

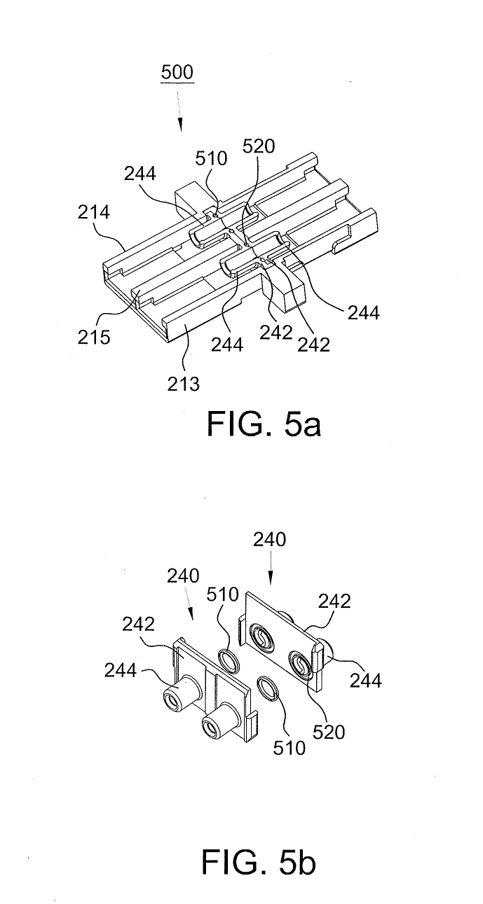

Referring to FIGS. 5a and 5b, the optical fiber adapter 500 according to the present disclosure is substantially the same as the optical fiber adapter 200 of FIG. 2, where identical reference numbers has been used when designating substantially identical elements that are common to the figures. However, the adapter 500 of the present disclosure further has two annular elastic bodies 510 sandwiched in between the flanges 242. The two annular elastic bodies 510 are positioned around the openings of the cylinders 244 on each of the flanges 242, respectively. A plurality of annular indentations 520 is formed on the back side of at least one of the flanges 242 to receive the elastic bodies 510, respectively. The annular elastic bodies 510 are arranged in tight contact with the back sides of the flanges 242.

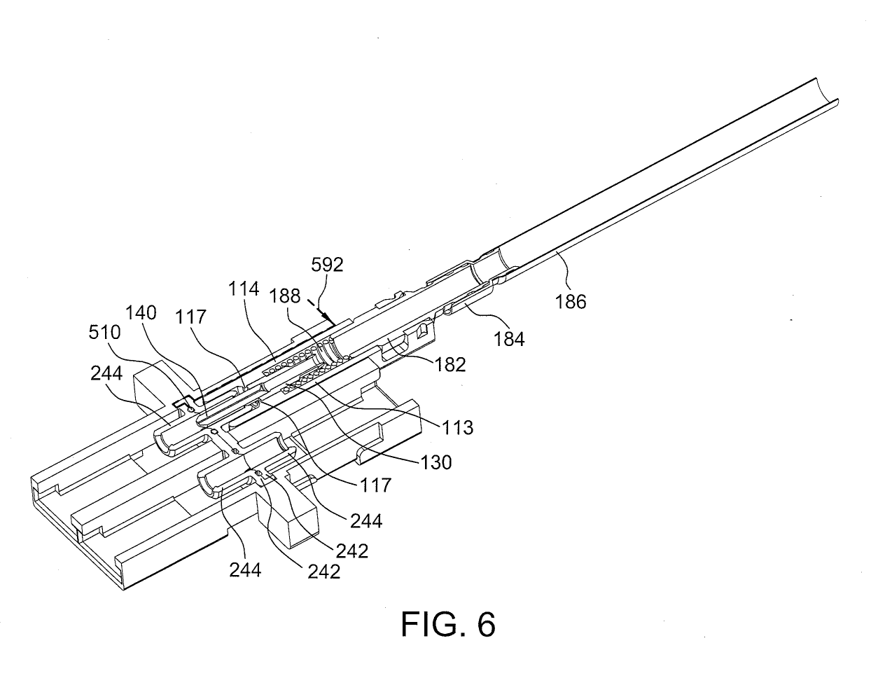

Referring to FIG. 6, when the connector 100 is fully inserted into the either of the left and right axial cavities of the adapter 500 of the present disclosure, the hollow cylinder 244 of the adapter 500 will be inserted into the connector 100 through the opening 116 and the ferrule 140 of the connector 100 will be inserted into the hollow cylinder 244 of the adapter 500. Because the annular elastic bodies 510 are arranged in tight contact with the back sides of the flanges 242, external dust and water will fail to enter the hollow cylinder 244 along the route 592 to contaminate the ferrule 140 therein when the connector 100 is fully inserted into the adapter 500.

Although the present disclose has been explained in detailed with duplex optical fiber adapter, it will be appreciated that the optical fiber adapter of the present disclosure may include simplex or other types of adapters.

Although the preferred embodiments of the disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. An optical fiber connector, comprising:
a hollow housing, wherein an annular protrusion is formed on inner walls of the housing;
a ferrule holder positioned within the housing;
a spring positioned to push the ferrule holder toward the annular protrusion;
a ferrule mounted on the ferrule holder, wherein the ferrule is pushed through the annular protrusion; and
an elastic body positioned around the ferrule holder and in contact with the inner walls of the housing.

2. The optical fiber connector as claimed in claim 1, wherein an indentation is formed on the ferrule holder to receive the elastic body.

3. The optical fiber connector as claimed in claim 1, wherein the optical fiber connector is an LC type optical fiber connector.

4. An optical fiber adapter, comprising:
a hollow main body;
a pair of inner housings positioned within the main body, each of the inner housings having a flange and a hollow cylinder, the flange having a front side and a back side, the cylinder extending from the front side, the cylinder having an opening formed on the back side of the flange, wherein the back sides of the flanges of the two inner housings are attached to each other; and
an elastic body sandwiched in between the flanges of the two inner housings and positioned around the openings on the back sides of the flanges.

5. The optical fiber adapter as claimed in claim 4, wherein an indentation is formed on one of the flanges to receive the elastic body.

6. The optical fiber adapter as claimed in claim 4, wherein the optical fiber adapter is an LC type optical fiber adapter.
